(19) United States
(12) Patent Application Publication
(10) Pub. No.: US 2010/0227612 A1
(43) Pub. Date: Sep. 9, 2010

(54) CELL DETECTION FOR MOBILE LOCATION WITH GROUPING DIVERSITY

(75) Inventors: Michael M. Wang, San Diego, CA (US); Ravi Palanki, San Diego, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/400,675

(22) Filed: Mar. 9, 2009

(51) Int. Cl. H04W 72/04; H04W 48/20; H04L 27/28

(52) U.S. Cl. 455/434; 375/260; 455/450

(57) ABSTRACT

Systems and methodologies are described that facilitate transmitting pilot signals over resources selected based on a dynamic variable common to a wireless network. The resources can also be selected based on an identifier of a related access point to provide multiple levels of diversity in transmitting the pilot signal. Thus, a resource selected for a given access point can vary over subsequent frames and additionally vary with respect to other access points. A hash function can be utilized with the access point identifier to divide resources among access points, and using the dynamic variable, such as a frame identifier, can modify the selected resources over subsequent frames. This allows mobile devices to receive the pilot signals from access points at varying locations, for location determination in one example, with decreased interference.

### BACKGROUND

1. Field

The following description relates generally to wireless communications, and more particularly to pilot signal transmission.

2. Background

Wireless communication systems are widely deployed to provide various types of communication content such as, for example, voice, data, and so on. Typical wireless communication systems may be multiple-access systems capable of supporting communication with multiple users by sharing available system resources (e.g., bandwidth, transmit power, . . . ). Examples of such multiple-access systems may include code division multiple access (CDMA) systems, time division multiple access (TDMA) systems, frequency division multiple access (FDMA) systems, orthogonal frequency division multiple access (OFDMA) systems, and the like. Additionally, the systems can conform to specifications such as third generation partnership project (3GPP), 3GPP long term evolution (LTE), ultra mobile broadband (UMB), and/or multi-carrier wireless specifications such as evolution data optimized (EV-DO), one or more revisions thereof, etc.

Generally, wireless multiple-access communication systems may simultaneously support communication for multiple mobile devices. Each mobile device may communicate with one or more access points (e.g., base stations) via transmissions on forward and reverse links. The forward link (or downlink) refers to the communication link from access points to mobile devices, and the reverse link (or uplink) refers to the communication link from mobile devices to access points. Further, communications between mobile devices and access points may be established via single-input single-output (SISO) systems, multiple-input single-output (MISO) systems, multiple-input multiple-output (MIMO) systems, and so forth. In addition, mobile devices can communicate with other mobile devices (and/or access points with other access points) in peer-to-peer wireless network configurations.

Locating mobile devices moving throughout a wireless network is typically accomplished using global positioning system (GPS) where the devices are so equipped. Alternatively, mechanisms such as triangulation based on signals received from one or more access points can be utilized to locate mobile devices. For example, mobile devices can attempt to receive pilot signals from various access points and determine a distance of the respective access point based on the pilot signal. Since location of access points are typically known in a wireless network, the mobile devices can be located by triangulating the determined distances from the access points in view of the known access point locations. Current wireless network deployments, however, can experience collision among the pilot signals since the mobile device can be closest to one of the access points. Thus, the closest access point can interfere with pilot signal transmissions from those access points further from the mobile device, which can complicate mobile location through triangulation.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with facilitating transmitting access point pilot signals with diversity to minimize interference from surrounding access points. In one example, access points can determine a time period and/or frequency over which pilot transmission is allowed for the access point. This can change over time, for example, so that access points whose pilots interfere in one time period have a high likelihood of not interfering in the next time period. In one example, a pilot transmission period for a given access point can be a function of a related identifier and a dynamic value. In this regard, devices performing location using a set of access point pilots can receive the pilots with decreasing likelihood of interference over time, facilitating greater accuracy in performing triangulation.

According to related aspects, a method is provided including selecting at least one of a plurality of allocated resources in a wireless network for transmitting a pilot signal based at least in part on a dynamic variable modified over time and common to the wireless network. The method also includes transmitting the pilot signal over the at least one allocated resource.

Another aspect relates to a wireless communications apparatus. The wireless communications apparatus can include at least one processor configured to compute an index related to transmitting a pilot signal based at least in part on a dynamic variable common to a wireless network. The at least one processor is further configured to determine an allocated resource corresponding to the index and transmit the pilot signal over the allocated resource. The wireless communications apparatus also comprises a memory coupled to the at least one processor.

Yet another aspect relates to an apparatus that includes means for selecting a resource allocated in a wireless network for transmitting a pilot signal based at least in part on a dynamic variable common to the wireless network. The apparatus can additionally include means for transmitting a pilot signal over the selected resource.

Still another aspect relates to a computer program product, which can have a computer-readable medium including code for causing at least one computer to calculate an index related to transmitting a pilot signal based at least in part on a dynamic variable common to a wireless network. The computer-readable medium can also comprise code for causing the at least one computer to determine an allocated resource corresponding to the index. Moreover, the computer-readable medium can comprise code for causing the at least one computer to transmit the pilot signal over the allocated resource.

Moreover, an additional aspect relates to an apparatus. The apparatus can include a pilot resource selection component that selects at least one of a plurality of allocated resources in a wireless network for transmitting a pilot signal based at least in part on a dynamic variable modified over time and common to the wireless network. The apparatus further includes a transmitting component that transmits the pilot signal over the selected allocated resource.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed and this description is intended to include all such aspects and their equivalents.

### BRIEF DESCRIPTION OF THE DRAWINGS

FIG. 1 is an illustration of a wireless communication system in accordance with various aspects set forth herein.

FIG. 2 is an illustration of a wireless communication network in accordance with aspects described herein.

FIG. 3 is an illustration of an example communications apparatus for employment within a wireless communications environment.

FIG. 4 is an illustration of an example wireless communications system that effectuates transmitting pilot signals over resources selected based on a dynamic wireless network variable.

FIG. 5 is an illustration of an example methodology that facilitates transmitting pilot signals in a wireless network.

FIG. 6 is an illustration of an example methodology that facilitates computing a location from received wireless network signals.

FIG. 7 is an illustration of an example mobile device that facilitates determining location from signals transmitted in a wireless network.

FIG. 8 is an illustration of an example system that transmits pilot signals using selected resources that vary over time.

FIG. 9 is an illustration of an example wireless network environment that can be employed in conjunction with the various systems and methods described herein.

FIG. 10 is an illustration of an example system that selects resources for transmitting pilot signals in a wireless network and transmits over the resources.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal A terminal can also be called a system, device, subscriber unit, subscriber station, mobile station, mobile, mobile device, remote station, remote terminal, access terminal, user terminal, terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication systems such as CDMA, TDMA, FDMA, OFDMA, SC-FDMA and other systems. The terms “system” and “network” are often used interchangeably. A CDMA system may implement a radio technology such as Universal Terrestrial Radio Access (UTRA), cdma2000, etc. UTRA includes Wideband-CDMA (W-CDMA) and other variants of CDMA. Further, cdma2000 covers IS-2000, IS-95 and IS-856 standards. A TDMA system may implement a radio technology such as Global System for Mobile Communications (GSM). An OFDMA system may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM [symbol] , etc. UTRA and E-UTRA are part of Universal Mobile Telecommunication System (UMTS). 3GPP Long Term Evolution (LTE) is a release of UMTS that uses E-UTRA, which employs OFDMA on the downlink and SC-FDMA on the uplink. UTRA, E-UTRA, UMTS, LTE and GSM are described in documents from an organization named “3rd Generation Partnership Project” (3GPP). Additionally, cdma2000 and UMB are described in documents from an organization named “3rd Generation Partnership Project 2” (3GPP2). Further, such wireless communication systems may additionally include peer-to-peer (e.g., mobile-to-mobile) ad hoc network systems often using unpaired unlicensed spectrums, 802.xx wireless LAN, BLUETOOTH and any other short- or long-range, wireless communication techniques.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

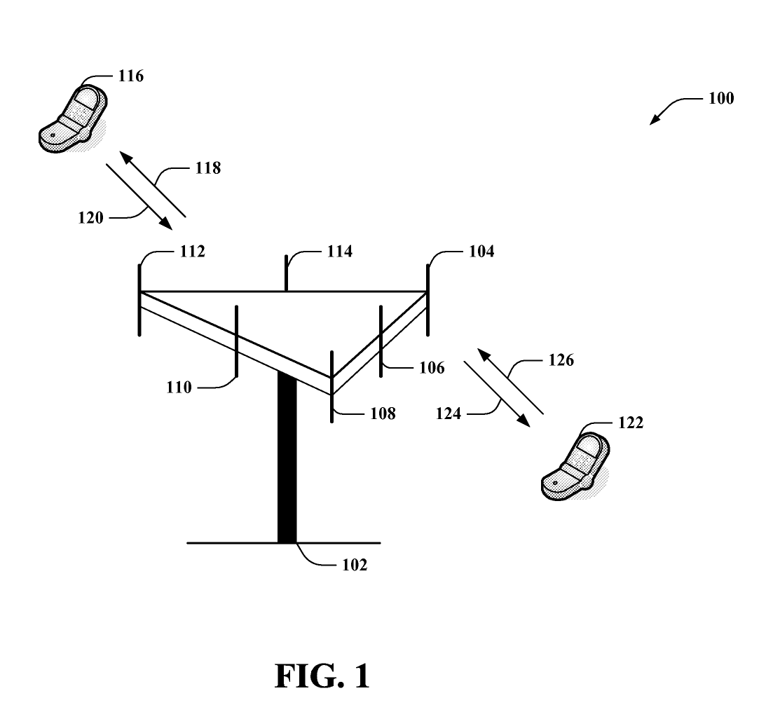

Referring now to FIG. 1, a wireless communication system 100 is illustrated in accordance with various embodiments presented herein. System 100 comprises a base station 102 that can include multiple antenna groups. For example, one antenna group can include antennas 104 and 106, another group can comprise antennas 108 and 110, and an additional group can include antennas 112 and 114. Two antennas are illustrated for each antenna group; however, more or fewer antennas can be utilized for each group. Base station 102 can additionally include a transmitter chain and a receiver chain, each of which can in turn comprise a plurality of components associated with signal transmission and reception (e.g., processors, modulators, multiplexers, demodulators, demultiplexers, antennas, etc.), as will be appreciated by one skilled in the art.

Base station 102 can communicate with one or more mobile devices such as mobile device 116 and mobile device 122; however, it is to be appreciated that base station 102 can communicate with substantially any number of mobile devices similar to mobile devices 116 and 122. Mobile devices 116 and 122 can be, for example, cellular phones, smart phones, laptops, handheld communication devices, handheld computing devices, satellite radios, global positioning systems, PDAs, and/or any other suitable device for communicating over wireless communication system 100. As depicted, mobile device 116 is in communication with antennas 112 and 114, where antennas 112 and 114 transmit information to mobile device 116 over a forward link 118 and receive information from mobile device 116 over a reverse link 120. Moreover, mobile device 122 is in communication with antennas 104 and 106, where antennas 104 and 106 transmit information to mobile device 122 over a forward link 124 and receive information from mobile device 122 over a reverse link 126. In a frequency division duplex (FDD) system, forward link 118 can utilize a different frequency band than that used by reverse link 120, and forward link 124 can employ a different frequency band than that employed by reverse link 126, for example. Further, in a time division duplex (TDD) system, forward link 118 and reverse link 120 can utilize a common frequency band and forward link 124 and reverse link 126 can utilize a common frequency band.

Each group of antennas and/or the area in which they are designated to communicate can be referred to as a sector of base station 102. For example, antenna groups can be designed to communicate to mobile devices in a sector of the areas covered by base station 102. In communication over forward links 118 and 124, the transmitting antennas of base station 102 can utilize beamforming to improve signal-to-noise ratio of forward links 118 and 124 for mobile devices 116 and 122. Also, while base station 102 utilizes beamforming to transmit to mobile devices 116 and 122 scattered randomly through an associated coverage, mobile devices in neighboring cells can be subject to less interference as compared to a base station transmitting through a single antenna to all its mobile devices. Moreover, mobile devices 116 and 122 can communicate directly with one another using a peer-to-peer or ad hoc technology (not shown).

According to an example, system 100 can be a multiple-input multiple-output (MIMO) communication system. Further, system 100 can utilize substantially any type of duplexing technique to divide communication channels (e.g., forward link, reverse link, . . . ) such as FDD, FDM, TDD, TDM, CDM, and the like. In addition, communication channels can be orthogonalized to allow simultaneous communication with multiple devices over the channels; in one example, OFDM can be utilized in this regard. Thus, the channels can be divided into portions of frequency over a period of time. In addition, frames can be defined as the portions of frequency over a collection of time periods; thus, for example, a frame can comprise a number of OFDM symbols. The base station 102 can transmit pilot signals over assigned frequencies in a frame (e.g., over one or more frequency locations—e.g., tones—of one or more OFDM symbols in the frame), which allow the mobile devices 116 and 122 to identify the base station 102 and/or acquire further parameters to communicate therewith. For example, the frequencies allocated for pilot signal transmission can be assigned by an underlying wireless network, provisioned at the base station 102, and/or the like. By allocating certain frequencies and/or time periods for pilot transmission, interference over data channels can be minimized.

In one example, pilot signals can be transmitted by the base station 102 using substantially high power and/or over a small number of tones creating a strong signal that can be highly decodable by surrounding devices (e.g., mobile devices 116 and 122). In addition, the base station 102 can transmit the pilot signals so as not to interfere with other neighboring base stations (not shown). Thus, according to a number of resources in a given frame or collection of frames allocated for transmitting pilot signals, the base station 102 can select resources as a function of an identifier of the base station 102. To further mitigate interference from pilot signals of surrounding base stations, the base station 102 can also select resources further as a function of a variable that is dynamic for each pilot signal transmitting opportunity, frame, collection of frames, and/or the like. The mobile devices 116 and/or 122 can receive the pilot signal transmitted from the base station 102 and decode the pilot signal to determine information related to the base station 102, for example. This information can be utilized in triangulating or otherwise.

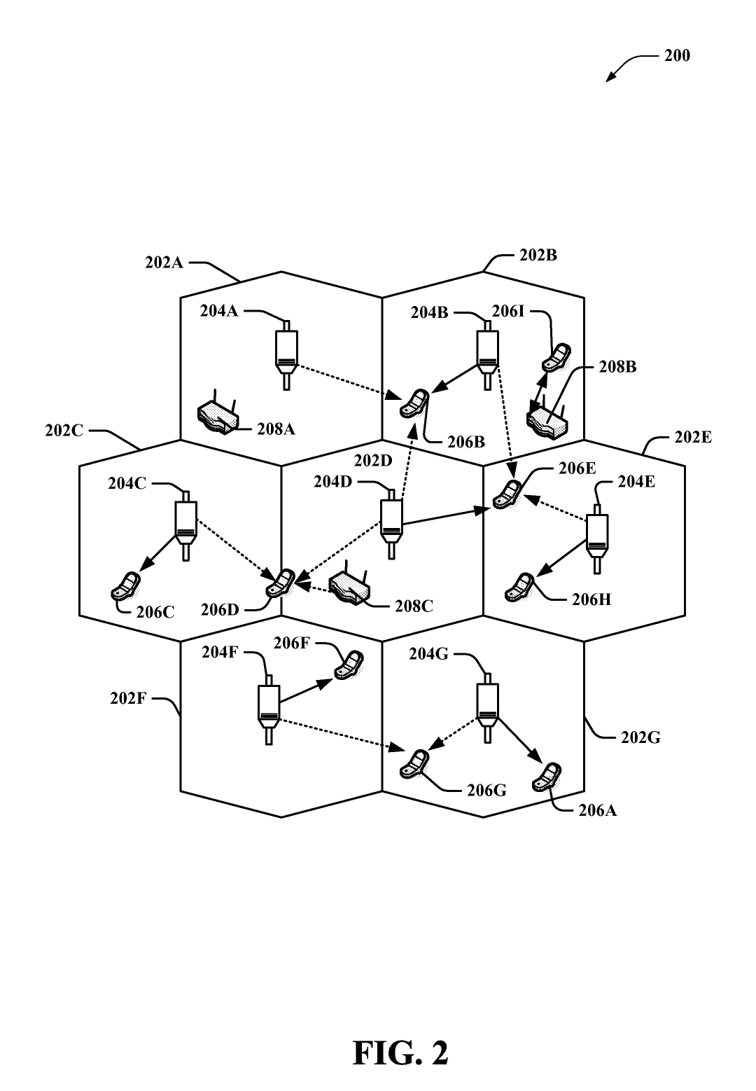

Now referring to FIG. 2, a wireless communication system 200 configured to support a number of mobile devices is illustrated. The system 200 provides communication for multiple cells, such as for example, macrocells 202A-202G, with each cell being serviced by a corresponding access point 204A-204G. As described previously, for instance, the access points 204A-204G related to the macrocells 202A-202G can be base stations. Mobile devices 206A-206I are shown dispersed at various locations throughout the wireless communication system 200. Each mobile device 206A-206I can communicate with one or more access points 204A-204G on a forward link and/or a reverse link, as described. In addition, access points 208A-208C are shown. These can be smaller scale access points, such as femtocells, picocells, relay cells, mobile base stations, and/or the like, offering services related to a particular service location, as described. The mobile devices 206A-206I can additionally or alternatively communicate with these smaller scale access points 208A-208C to receive offered services. The wireless communication system 200 can provide service over a large geographic region, in one example (e.g., macrocells 202A-202G can cover a few blocks in a neighborhood, and the smaller scale access points 208A-208C can be present in areas such as residences, office buildings, and/or the like as described). In an example, the mobile devices 206A-206I can establish connection with the access points 204A-204G and/or 208A-208C over the air and/or over a backhaul connection.

Additionally, as shown, the mobile devices 206A-206I can travel throughout the system 200 and can reselect cells related to the various access points 204A-204G and/or 208A-208C as it moves through the different macrocells 202A-202G or femtocell coverage areas. In addition, mobile devices can prefer connection to some smaller scale access points. For example, though mobile device 206I is in macrocell 202B, and thus in coverage area of access point 204B, it can communicate with the smaller scale access point 208B instead of (or in addition to) access point 204B. In one example, the smaller scale access point 208B can provide additional services to the mobile device 206I, such as desirable billing or charges, minute usage, enhanced services (e.g., faster broadband access, media services, etc.). In addition, as described, the access points 204A-204G and/or smaller scale access points 208A-208C can transmit pilot signals allowing the mobile devices 206A-206I to identify the access points and obtain parameters to establish further communication therewith. Furthermore, the mobile devices 206A-206I can locate themselves using triangulation based on computing a distance to one or more of the access points 204A-204G (and/or smaller scale access points 208A-208C where location information is attainable) and determining a location of the access points 204A-204G.

According to an example, the access points 204A-204G can transmit pilot signals using allocated resources selected according to an identifier related to the specific access point to add some level of diversity to the resource selection. The resources can be allocated, as mentioned, by an underlying wireless network, and can relate to clusters of resources, in one example. Since there can be more base stations than allocated pilot signal resources, selecting resources using such a static identifier can result in some of the access points 204A-204G (or additional access points) sharing pilot signal transmission resources. Where access points sharing pilot signal resources are beyond a threshold distance, this can be of little to no consequence. Where the sharing access points are within proximity, however, the conflicting pilot signal transmissions can affect the ability to receive both signals, and thus the ability for mobile device location.

In this regard, pilot signal transmission resources can be selected further based on a dynamic variable, known to the access points 204A-204G (and/or femtocell access points 208A-208C) that changes over time, such as a frame identifier. For example, adding a frame identifier to an access point identifier can result in different values, and thus different resources, over time. This can mitigate interference for pilot signal transmissions between two access points such that where the access points interfere in a first frame, their likelihood of interfering in a subsequent frame diminishes greatly (and even more for the next frame, etc.).

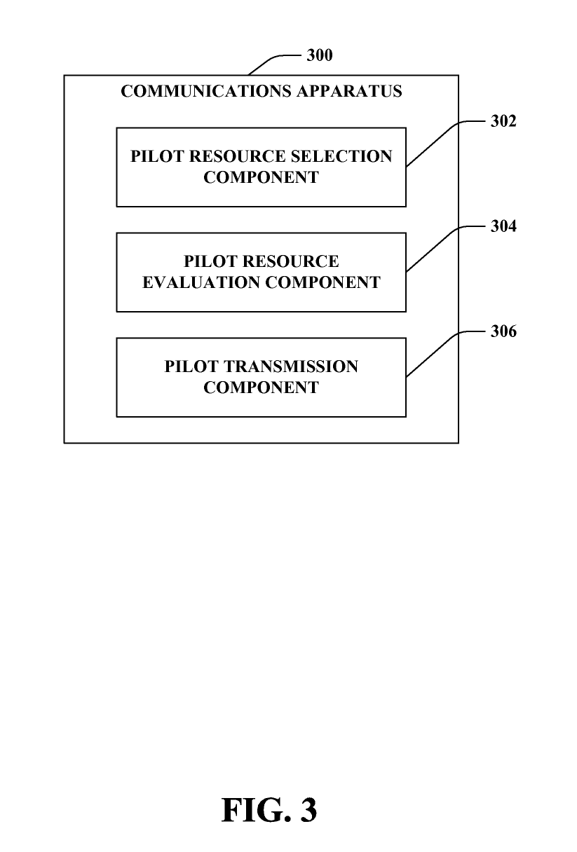

Turning to FIG. 3, illustrated is a communications apparatus 300 for employment within a wireless communications environment. The communications apparatus 300 can be an access point or a portion thereof, or substantially any communications apparatus that communicates over and/or provides access to a wireless network. The communications apparatus 300 can include a pilot resource selection component 302 that can compute a pilot resource for transmitting a pilot signal based at least in part on an identifier of the communication apparatus 300, a pilot resource evaluation component 304 that can analyze a current resource to determine whether it is a resource computed by the pilot resource selection component 302, and a pilot transmission component 306 that can transmit a pilot signal over the pilot resource to facilitate identifying and communicating with the communications apparatus 300.

According to an example, the communications apparatus 300 can operate in a wireless network having allocated frequency resources over time for transmitting pilot signals. In one example, the communications apparatus 300 can be pre-programmed or provisioned with resource allocation information or can otherwise acquire the information from an underlying network component, other devices participating in the network, and/or the like. The resources can be allocated in many configurations, including a set of contiguous frequencies over one or more time periods in a frame, clusters of frequency over time periods in a frame (e.g., clusters of tones of OFDM symbols in a frame), and/or the like. The pilot resource selection component 302 can determine one or more of the resources for transmitting a pilot signal indicating identification information for the communication apparatus 300. As described, this can be a high powered signal that can be received in other areas over other communication signals between disparate devices.

The pilot resource selection component 302, for example, can select a pilot transmission resource based at least in part on an identifier related to the communications apparatus 300, which can be a base station ID, cell group ID, etc. Thus, for example, the pilot resource selection component 302 can utilize the identifier in a function to determine one or more resources over one or more frames for transmitting the pilot signal introducing a level of diversity. In one example, a hash function can be utilized in conjunction with the identifier. For example, the resource selected can relate to an index computed by Hash (CellGroupID) mod M, where CellGroupID can be an identifier related to the communications apparatus 300 and M is a multiplexing factor. The computed index, for example, can correspond to one of the allocated resources in a given frame or set of frames for transmitting pilot signals. Thus, the index can relate not only to a resource in contiguous frequencies over time, but also to one or more clusters where the pilot resources are clustered, as described.

Using the formula above, for example, can result in the same resource selection for access points in each frame. Thus, where the formula results in the same selection for two access points, those two access points will always transmit pilot signals over the same resources. This can be undesirable, in one example, where the access points are in proximity, as described. In another example, however, the pilot resource selection component 302 can additionally or alternatively consider a dynamic variable when computing the resource in the frame, set of frames, cluster, etc., for transmitting the pilot signal. In one example, a current frame identifier can be the dynamic variable known in the wireless network. Thus, for example, the pilot resource selection component 302 can compute the resource as Hash (CellGroupID+FrameID) mod M, adding another level of diversity in the frame identifier. Adding a dynamic variable that changes for given pilot transmissions, and is known by devices in a wireless network, increases the likelihood that access points selecting the same resource for a given pilot transmission will not select the same resource for a subsequent pilot transmission. It is to be appreciated that the dynamic variable can be utilized in substantially any formula so long is the result is the pilot resource selection component 302 selecting a different pilot transmission resource than other access points in each frame, set of frames, cluster, and/or the like.

Once the pilot resource selection component 302 determines a resource (e.g., frequency over time) over which to transmit the pilot signal, the pilot resource evaluation component 304 can determine when the resource time period is near. During the resource time period, the pilot transmission component 306 can transmit the pilot signal with high power to allow processing by a number of mobile devices. The pilot signal can be a highly detectable pilot (HDP) transmitted over an HDP cluster (e.g., where the pilot resource selection component 302 selects the appropriate cluster and/or resource within the cluster). In an example, the pilot resource selection component 302 can also reuse frequencies such that pilot signals from multiple communication apparatuses, such as communication apparatus 300, can occupy common time periods using disparate portions of frequency in the time period. Thus, in an OFDM configuration, for example, the communication apparatus 300 can occupy the same OFDM symbol in a frame as one or more disparate communication apparatuses transmitting pilot signals, but the pilot transmission component 306 can transmit the pilot over a disparate frequency resource, or tone, in the OFDM symbol.

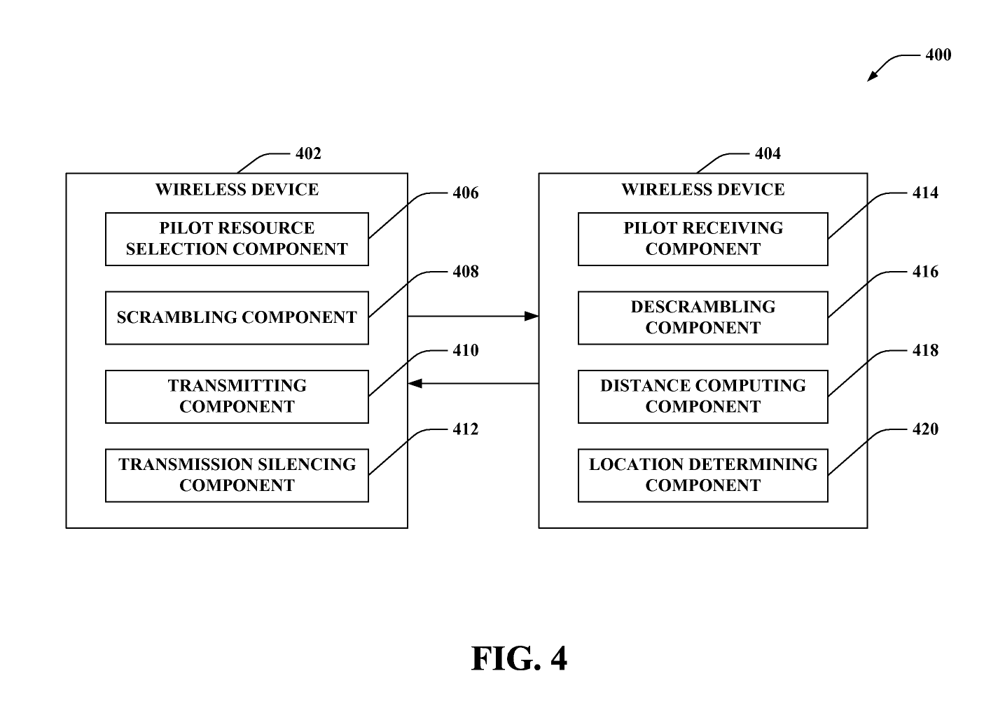

Now referring to FIG. 4, illustrated is a wireless communications system 400 that facilitates device location using received pilot signals. Wireless devices 402 and/or 404 can be a mobile device (including not only independently powered devices, but also modems, for example), a base station, and/or portion thereof, or substantially any wireless device. Moreover, system 400 can be a MIMO system and/or can conform to one or more wireless network system specifications (e.g., EV-DO, 3GPP, 3GPP2, 3GPP LTE, WiMAX, etc.) and can comprise additional components to facilitate communication between the wireless devices 402 and 404. In one example, the wireless device 402 have readily acquirable location information; for example, known GPS coordinates where the device 402 is stationary and/or reported or otherwise attainable GPS coordinates where the device 402 is mobile.

The wireless device 402 can comprise a pilot resource selection component 406 that can determine a pilot resource in a frame, set of frames, cluster, collection of clusters, etc., for transmitting a pilot signal, a scrambling component 408 that scrambles the pilot, which can be a sequence of frequency portions over time, a transmitting component 410 that transmits the pilot over the selected resource, and a transmission silencing component 412 that ensures the transmitting component 410 does not transmit over pilot resources other than the one or more selected resources. As described, the pilot resource selection component 406 can compute a resource over which to transmit the pilot signal as a function of an access point identifier and/or a dynamic variable to add varying levels of diversity to the calculation.

The wireless device 404 can comprise a pilot receiving component 414 that obtains pilot signals from various disparate wireless devices, a descrambling component 416 that can descramble a received pilot signal sequence, a distance computing component 418 that estimates a distance of one or more wireless devices based on received pilot signals, and a location determining component 420 that receives a location of one or more wireless devices and computes a location of the wireless device 404 using triangulation based on the one or more wireless device locations and estimated distances. In one example, the distance computing component 418 can limit distance computations to only those wireless devices for which a location is known, received, or receivable by one or more network components.

According to an example, the pilot resource selection component 406 can determine one or more pilot resources over which to transmit a pilot signal. The resources can be selected, as described, based at least in part on an identifier of the wireless device 402 and/or a dynamic variable known by devices in the wireless network. The scrambling component 408, in one example, can scramble the pilot signal further according to an identifier of the wireless device 402. The transmitting component 410 can transmit the pilot signal (e.g., an HDP) over the selected resources, as described, with high power to increase the area in which the pilot is detected. When the wireless device 402 is not transmitting its pilot signal, the transmission silencing component 412 can ensure the wireless device 402 does not transmit over other pilot signal resources to increase receipt of pilots from neighboring access points, in one example.

In this example, the pilot receiving component 414 can obtain the pilot signal transmitted by the transmitting component 410, as well as other pilot signals in the wireless network, as described. The descrambling component 416 can descramble the received pilot signal based at least in part on an identifier of the wireless device 402. In one example, the descrambling component 416 can acquire the identifier based at least in part on the received pilot signal. Thus, for example, the descrambling component 416 can reverse the pilot selection function using the known dynamic variable (e.g., frame identifier) and/or other known values to determine the identifier. The distance computing component 418 can estimate a distance to the wireless device 402 based at least in part on the received pilot signal (e.g., by estimating pathloss, evaluating strength of the signal, and/or the like). The location determining component 420 can acquire location of the wireless device 402 via known parameters, requesting location from the wireless device 402 or other device in the wireless network and/or the like, and compute the location of the wireless device 404 using triangulation, as described.

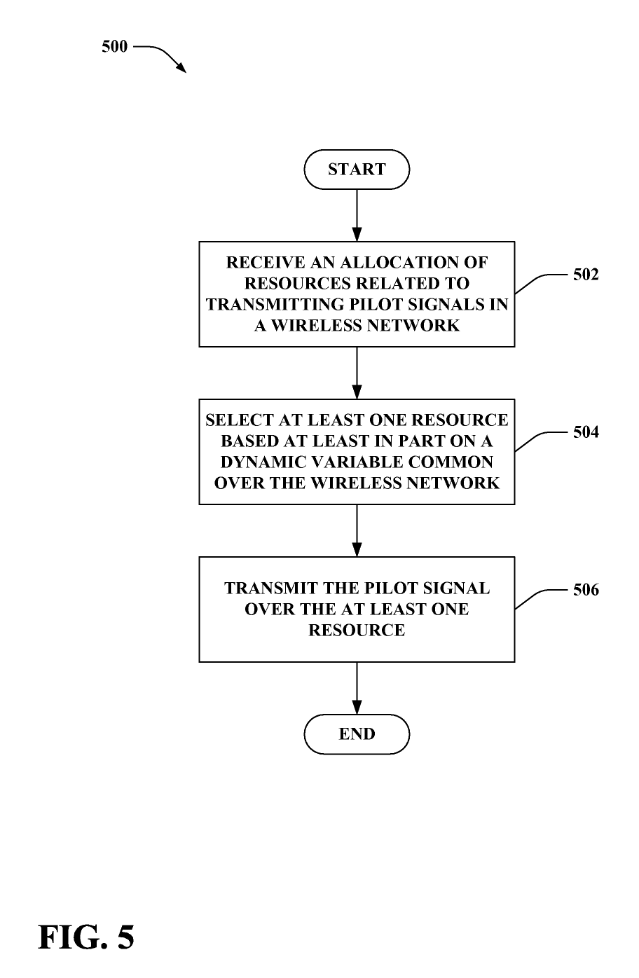

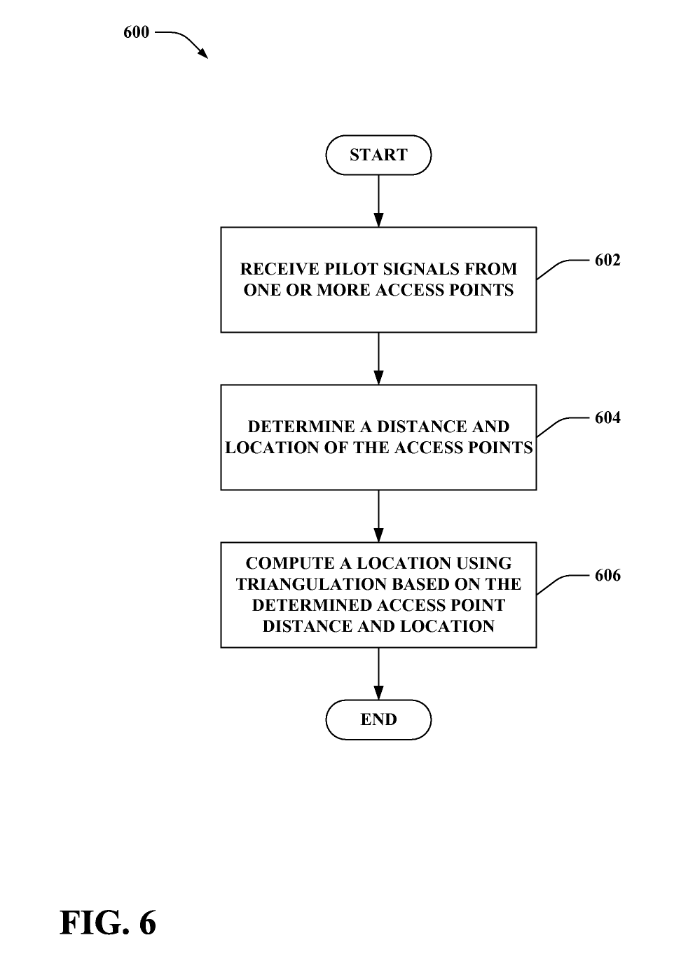

Referring to FIGS. 5-6, methodologies relating to transmitting pilot signals over resources determined based on one or more dynamic variables common to a wireless network are illustrated. While, for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

Turning to FIG. 5, an example methodology 500 that facilitates transmitting pilot signals over resources selected based at least in part on a dynamic variable common to a wireless network is illustrated. At 502, an allocation of resources related to transmitting pilot signals in a wireless network can be received. The allocation of resources can be pre-programmed or provisioned, received by one or more components or devices of a wireless network, and/or the like, as described. In addition, the resources can relate to a collection of frequency resources, or tones, in an OFDM symbol. Moreover, the resources can be clustered in a given communication frame. In either case, the resources can be identifiable based on an index. At 504, at least one resource can be selected based at least in part on a dynamic variable common over the wireless network. The resource can be selected, for example, based on a related index computed using the dynamic variable, as described.

In addition, the related index can be computed based on an identifier of an access point. In one example, the dynamic variable can relate to a frame identifier that increments with each communication frame encountered. Thus, utilizing the access point identifier and a frame identifier provides diversity for selecting the resource with respect to a plurality of access points, as described. In this regard, the selected resource can vary for a given frame, and using the dynamic variable in computing the resource index with the identifier can increase likelihood that the selected resource varies in a subsequent frame for access points having conflicting selected resources in a current frame, as described. At 506, the pilot signal can be transmitted over the at least one resource. It is to be appreciated that the selected resource can be determined in a current frame and/or proactively such that a future frame for transmitting the pilot can be determined.

Referring to FIG. 6, an example methodology 600 is shown that facilitates determining location based on a plurality of received pilot signals. At 602, pilot signals from one or more access points can be received. As described, the pilot signals can be HDPs transmitted in periods chosen based on an identifier of a respective access point modified by a dynamic variable common to a wireless network. If a pilot signal in one frame is interfered by another pilot signal, it is likely that the pilot signals will not interfere in a subsequent frame based on the diversity in selecting resources, as described. At 604, a distance and location of the access points can be determined. As described, the distance can be discerned based at least in part on estimating a pathloss related to a transmitted signal, a signal strength, and/or the like. The location can be received from the access points upon request, specified in the pilot, retrieved from the wireless network and/or the like. At 606, a current location can be computed using triangulation based on the determined access point locations and distances.

It will be appreciated that, in accordance with one or more aspects described herein, inferences can be made regarding selecting a pilot resource for transmitting pilot signals according to a dynamic variable and/or other identifiers, estimating distance of access points transmitting pilot signals, and/or the like. As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

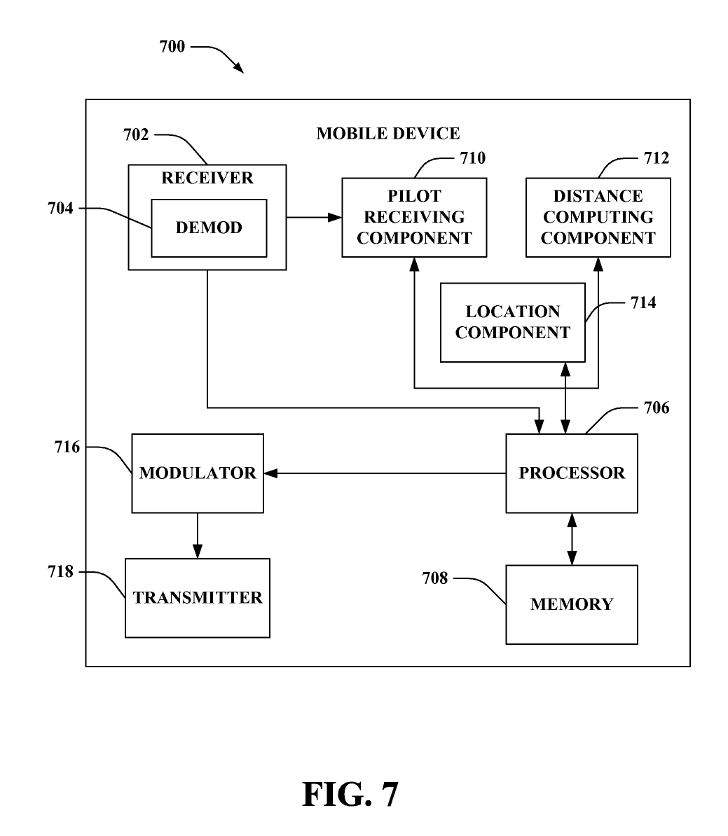

FIG. 7 is an illustration of a mobile device 700 that facilitates computing location from a number of received pilot signals in a wireless network. Mobile device 700 comprises a receiver 702 that receives one or more signals over one or more carriers from, for instance, a receive antenna (not shown), performs typical actions on (e.g., filters, amplifies, downconverts, etc.) the received signals, and digitizes the conditioned signals to obtain samples. Receiver 702 can comprise a demodulator 704 that can demodulate received symbols and provide them to a processor 706 for channel estimation. Processor 706 can be a processor dedicated to analyzing information received by receiver 702 and/or generating information for transmission by a transmitter 718, a processor that controls one or more components of mobile device 700, and/or a processor that both analyzes information received by receiver 702, generates information for transmission by transmitter 718, and controls one or more components of mobile device 700.

Mobile device 700 can additionally comprise memory 708 that is operatively coupled to processor 706 and that can store data to be transmitted, received data, information related to available channels, data associated with analyzed signal and/or interference strength, information related to an assigned channel, power, rate, or the like, and any other suitable information for estimating a channel and communicating via the channel. Memory 708 can additionally store protocols and/or algorithms associated with estimating and/or utilizing a channel (e.g., performance based, capacity based, etc.).

It will be appreciated that the data store (e.g., memory 708) described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The memory 708 of the subject systems and methods is intended to comprise, without being limited to, these and any other suitable types of memory.

Receiver 702 and/or processor 706 can further be operatively coupled to a pilot receiving component 710 that obtains pilot signals transmitted by a plurality of access points. As described, the pilot signals can be HDPs transmitted in accordance with aspects described herein to provide multiple levels of diversity to increase likelihood of successful receipt over time. The processor 706 can further be operatively coupled to a distance computing component 712 that estimates a distance to one or more access points based at least in part on pathloss, signal strength, and/or the like. In addition, the a location component 714 is provided to compute a location of the mobile device 700 based on the estimated distances and obtained location coordinates for the access points. As described, the location component 714 can compute the location using triangulation, for example. Mobile device 700 still further comprises a modulator 716 and transmitter 718 that respectively modulate and transmit signals to, for instance, a base station, another mobile device, etc. Although depicted as being separate from the processor 706, it is to be appreciated that the demodulator 704, pilot receiving component 710, distance computing component 712, location component 714, and/or modulator 716 can be part of the processor 706 or multiple processors (not shown).

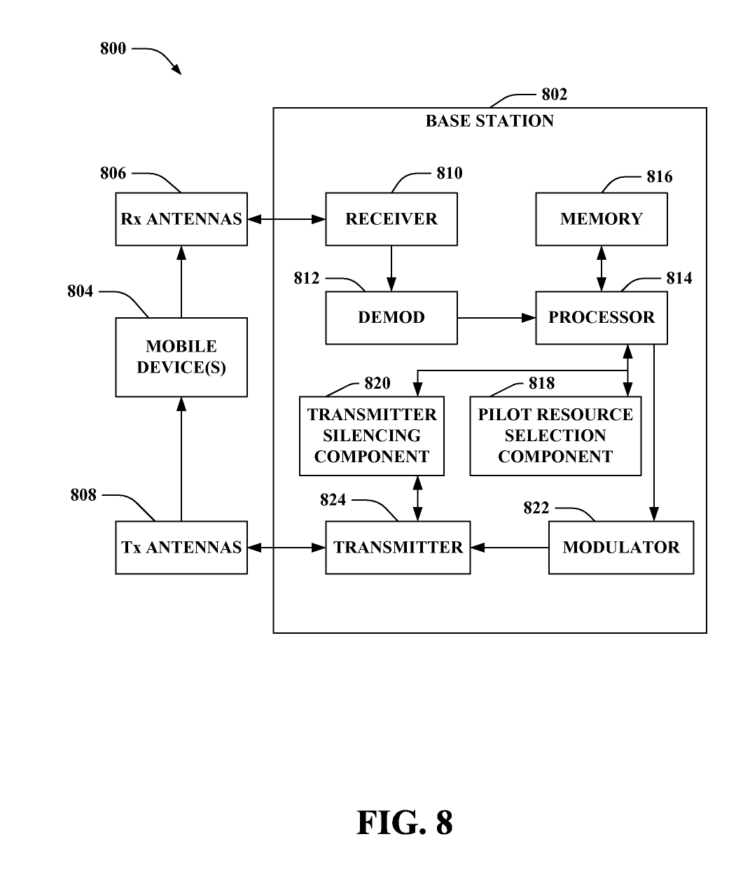

FIG. 8 is an illustration of a system 800 that facilitates transmitting pilot signals over one or more resources determined based on a common network variable. The system 800 comprises a base station 802 (e.g., access point, . . . ) with a receiver 810 that receives signal(s) from one or more mobile devices 804 through a plurality of receive antennas 806, and a transmitter 824 that transmits to the one or more mobile devices 804 through a transmit antenna 808. Receiver 810 can receive information from receive antennas 806 and is operatively associated with a descrambler that can decode received signals. Furthermore, demodulator 812 can demodulate received descrambled signals. Demodulated symbols are analyzed by a processor 814 that can be similar to the processor described above with regard to FIG. 7, and which is coupled to a memory 816 that stores information related to estimating a signal (e.g., pilot) strength and/or interference strength, data to be transmitted to or received from mobile device(s) 804 (or a disparate base station (not shown)), and/or any other suitable information related to performing the various actions and functions set forth herein. Processor 814 is further coupled to a pilot resource selection component 820 that determines an allocated resource for transmitting a pilot signal using transmitter 824 and a transmitter silencing component 820 that can cease transmission over pilot resources other than the determined allocated resource in a communication frame.

According to an example, the pilot resource selection component 818 can select a resource for transmitting a pilot signal based on a variable common to the wireless network. In addition, the pilot resource selection component 818 can select the resource based on an identifier related to the base station 802, as described. Further, in this regard, the dynamic variable can be a frame identifier or other variable that changes for a given communication period; thus, multiple levels of diversity are implemented for selecting the pilot transmission period to mitigate likelihood of interference over multiple time periods, as described. Moreover, the transmitter silencing component 820 can cease communication over pilot resources not utilized by the base station 802 for transmitting the pilot signal. This can additionally increase likelihood of the mobile devices 804 receiving pilot signals in the wireless network by mitigating interference among the signals. Furthermore, although depicted as being separate from the processor 814, it is to be appreciated that the demodulator 812, pilot resource selection component 818, transmitter silencing component 820, and/or modulator 822 can be part of the processor 814 or multiple processors (not shown).

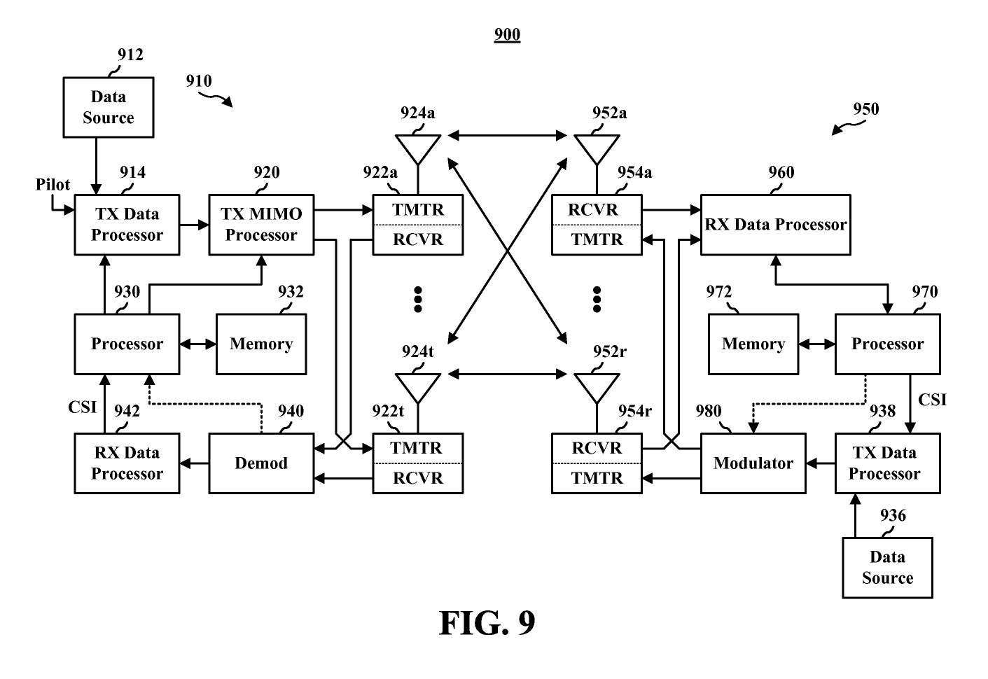

FIG. 9 shows an example wireless communication system 900. The wireless communication system 900 depicts one base station 910 and one mobile device 950 for sake of brevity. However, it is to be appreciated that system 900 can include more than one base station and/or more than one mobile device, wherein additional base stations and/or mobile devices can be substantially similar or different from example base station 910 and mobile device 950 described below. In addition, it is to be appreciated that base station 910 and/or mobile device 950 can employ the systems (FIGS. 1-4 and 7-8) and/or methods (FIGS. 5-6) described herein to facilitate wireless communication there between.

At base station 910, traffic data for a number of data streams is provided from a data source 912 to a transmit (TX) data processor 914. According to an example, each data stream can be transmitted over a respective antenna. TX data processor 914 formats, codes, and interleaves the traffic data stream based on a particular coding scheme selected for that data stream to provide coded data.

The coded data for each data stream can be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 950 to estimate channel response. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding, and modulation for each data stream can be determined by instructions performed or provided by processor 930.

The modulation symbols for the data streams can be provided to a TX MIMO processor 920, which can further process the modulation symbols (e.g., for OFDM). TX MIMO processor 920 then provides N_{T} modulation symbol streams to N_{T} transmitters (TMTR) 922a through 922t. In various aspects, TX MIMO processor 920 applies beamforming weights to the symbols of the data streams and to the antenna from which the symbol is being transmitted.

Each transmitter 922 receives and processes a respective symbol stream to provide one or more analog signals, and further conditions (e.g., amplifies, filters, and upconverts) the analog signals to provide a modulated signal suitable for transmission over the MIMO channel. Further, N_{T} modulated signals from transmitters 922a through 922t are transmitted from N_{T} antennas 924a through 924t, respectively.

At mobile device 950, the transmitted modulated signals are received by N_{R} antennas 952a through 952r and the received signal from each antenna 952 is provided to a respective receiver (RCVR) 954a through 954r. Each receiver 954 conditions (e.g., filters, amplifies, and downconverts) a respective signal, digitizes the conditioned signal to provide samples, and further processes the samples to provide a corresponding “received” symbol stream.

An RX data processor 960 can receive and process the N_{R} received symbol streams from N_{R} receivers 954 based on a particular receiver processing technique to provide N_{T} “detected” symbol streams. RX data processor 960 can demodulate, deinterleave, and decode each detected symbol stream to recover the traffic data for the data stream. The processing by RX data processor 960 is complementary to that performed by TX MIMO processor 920 and TX data processor 914 at base station 910.

A processor 970 can periodically determine which precoding matrix to utilize as discussed above. Further, processor 970 can formulate a reverse link message comprising a matrix index portion and a rank value portion.

The reverse link message can comprise various types of information regarding the communication link and/or the received data stream. The reverse link message can be processed by a TX data processor 938, which also receives traffic data for a number of data streams from a data source 936, modulated by a modulator 980, conditioned by transmitters 954a through 954r, and transmitted back to base station 910.

At base station 910, the modulated signals from mobile device 950 are received by antennas 924, conditioned by receivers 922, demodulated by a demodulator 940, and processed by a RX data processor 942 to extract the reverse link message transmitted by mobile device 950. Further, processor 930 can process the extracted message to determine which precoding matrix to use for determining the beamforming weights.

Processors 930 and 970 can direct (e.g., control, coordinate, manage, etc.) operation at base station 910 and mobile device 950, respectively. Respective processors 930 and 970 can be associated with memory 932 and 972 that store program codes and data. Processors 930 and 970 can also perform computations to derive frequency and impulse response estimates for the uplink and downlink, respectively.

It is to be understood that the aspects described herein can be implemented in hardware, software, firmware, middleware, microcode, or any combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof.

When the aspects are implemented in software, firmware, middleware or microcode, program code or code segments, they can be stored in a machine-readable medium, such as a storage component. A code segment can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted using any suitable means including memory sharing, message passing, token passing, network transmission, etc.

For a software implementation, the techniques described herein can be implemented with modules (e.g., procedures, functions, and so on) that perform the functions described herein. The software codes can be stored in memory units and executed by processors. The memory unit can be implemented within the processor or external to the processor, in which case it can be communicatively coupled to the processor via various means as is known in the art.

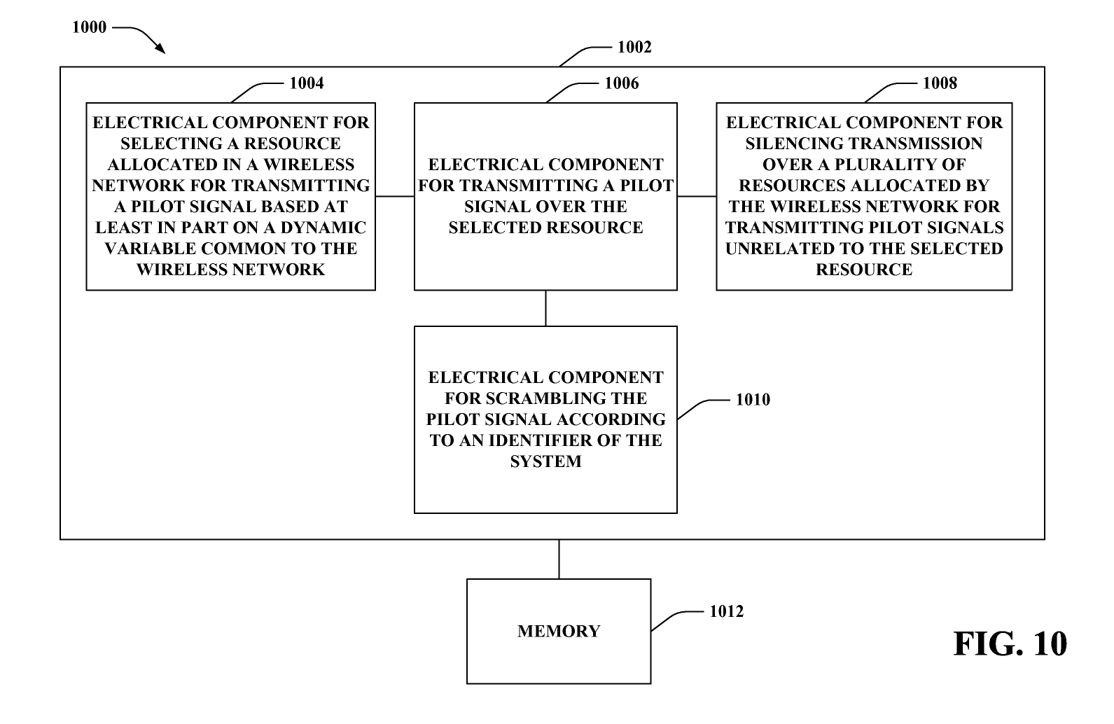

With reference to FIG. 10, illustrated is a system 1000 that transmits pilot signals over resources selected according to a dynamic variable common to a wireless network. For example, system 1000 can reside at least partially within a base station, mobile device, etc. It is to be appreciated that system 1000 is represented as including functional blocks, which can be functional blocks that represent functions implemented by a processor, software, or combination thereof (e.g., firmware). System 1000 includes a logical grouping 1002 of electrical components that can act in conjunction. For instance, logical grouping 1002 can include an electrical component for selecting a resource allocated in a wireless network for transmitting a pilot signal based at least in part on a dynamic variable common to the wireless network 1004. For example, as described, the variable can be a frame identifier or other variable that changes over a period of time. In addition, as described, the electrical component 1004 can also select the resource based further in part on an identifier related to the system 1000. Using the dynamic and static identifiers introduces diversity into pilot resource selection as the selection can vary in each time period and vary among access points over the time periods, as described. Further, logical grouping 1002 can comprise an electrical component for transmitting a pilot signal over the selected resource 1006.

Furthermore, logical grouping 1002 can include an electrical component for silencing transmission over a plurality of resources allocated by the wireless network for transmitting pilot signals unrelated to the selected resource 1008. Thus, for example, of the resources allocated by the wireless network for transmitting pilot signals, the resources not selected by the system 1000 can be silenced with respect to the system 1000 to mitigate system 1000 interference with other access points. In addition, logical grouping 1002 can include an electrical component for scrambling the pilot signal according to an identifier of the system 1010. In this regard, the pilot signal is encoded and can be subsequently decoded by a device that can determine the system identifier, as described. Additionally, system 1000 can include a memory 1012 that retains instructions for executing functions associated with electrical components 1004, 1006, 1008, and 1010. While shown as being external to memory 1012, it is to be understood that one or more of electrical components 1004, 1006, 1008, and 1010 can exist within memory 1012.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Furthermore, to the extent that the term “includes” is used in either the detailed description or the claims, such term is intended to be inclusive in a manner similar to the term “comprising” as “comprising” is interpreted when employed as a transitional word in a claim. Furthermore, although elements of the described aspects and/or aspects may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise.

What is claimed is:

1. A method, comprising:
selecting at least one of a plurality of allocated resources in a wireless network for transmitting a pilot signal based at least in part on a dynamic variable modified over time and common to the wireless network; and
transmitting the pilot signal over the at least one allocated resource.

2. The method of claim 1, wherein the at least one allocated resource is selected further based at least in part on an identifier of an access point in the wireless network.

3. The method of claim 2, wherein the dynamic variable is an identifier of a current frame.

4. The method of claim 3, wherein selection of the at least one allocated resource is based at least in part on computing an index of the at least one allocated resource based at least in part on a hash function involving the identifier of the access point and the current frame identifier modulo a multiplexing factor.

5. The method of claim 1, wherein the plurality of allocated resources relate to a number of tones in a collection of orthogonal frequency division multiplexing (OFDM) symbols.

6. The method of claim 5, wherein the allocated resources further relate to clusters of tones in the collection of OFDM symbols.

7. The method of claim 5, wherein one or more access points transmit pilot signals over disparate tones of an OFDM symbol corresponding to the at least one allocated resource.

8. The method of claim 1, further comprising silencing transmission over one or more of the plurality of allocated resources.

9. The method of claim 1, further comprising scrambling the pilot signal according to an identifier of an access point.

10. The method of claim 1, wherein the plurality of allocated resources are defined according to a specification of the wireless network.

11. A wireless communications apparatus, comprising:
at least one processor configured to:
compute an index related to transmitting a pilot signal based at least in part on a dynamic variable common to a wireless network;
determine an allocated resource corresponding to the index; and
transmit the pilot signal over the allocated resource; and
a memory coupled to the at least one processor.

12. The wireless communications apparatus of claim 11, wherein the index is further computed based at least in part on an identifier of the wireless communications apparatus.

13. The wireless communications apparatus of claim 12, wherein the dynamic variable is a frame identifier that increments during each communication frame of a wireless network.

14. The wireless communications apparatus of claim 12, wherein the at least one processor is further configured to scramble the pilot signal based at least in part on the identifier of the wireless communication apparatus.

15. The wireless communications apparatus of claim 11, wherein the at least one processor is further configured to cease transmission over a plurality of resources allocated for transmitting pilot signals unrelated to the resource corresponding to the index.

16. An apparatus, comprising:
means for selecting a resource allocated in a wireless network for transmitting a pilot signal based at least in part on a dynamic variable common to the wireless network; and
means for transmitting a pilot signal over the selected resource.

17. The apparatus of claim 16, wherein the means for selecting the resource further selects the resource based at least in part on an identifier related to the apparatus.

18. The apparatus of claim 17, wherein the dynamic variable is an identifier of a current communication frame in the wireless network.

19. The apparatus of claim 16, wherein the resource is one of a plurality of resources allocated by the wireless network relating to a number of tones in a collection of orthogonal frequency division multiplexing (OFDM) symbols.

20. The apparatus of claim 16, further comprising means for silencing transmission over a plurality of resources allocated by the wireless network for transmitting pilot signals unrelated to the selected resource.

21. The apparatus of claim 16, further comprising means for scrambling the pilot signal according to an identifier of the apparatus.

22. A computer program product, comprising:
a computer-readable medium comprising:
code for causing at least one computer to calculate an index related to transmitting a pilot signal based at least in part on a dynamic variable common to a wireless network;
code for causing the at least one computer to determine an allocated resource corresponding to the index; and
code for causing the at least one computer to transmit the pilot signal over the allocated resource.

23. The computer program product of claim 22, wherein the index is further computed based at least in part on an access point identifier.

24. The computer program product of claim 23, wherein the dynamic variable is a frame identifier that increments during each communication frame of a wireless network.

25. The computer program product of claim 23, wherein the computer-readable medium further comprises code for causing the at least one computer to scramble the pilot signal based at least in part on the identifier.

26. The computer program product of claim 22, wherein the computer-readable medium further comprises code for causing the at least one computer to cease transmission over a plurality of resources allocated for transmitting pilot signals unrelated to the resource corresponding to the index.

27. An apparatus, comprising:
a pilot resource selection component that selects at least one of a plurality of allocated resources in a wireless network for transmitting a pilot signal based at least in part on a dynamic variable modified over time and common to the wireless network; and
a transmitting component that transmits the pilot signal over the selected allocated resource.

28. The apparatus of claim 27, wherein the pilot resource selection component selects the at least one allocated resource further based at least in part on an identifier of the apparatus.

29. The apparatus of claim 28, wherein the dynamic variable is an identifier of a current communications frame in the wireless network.

30. The apparatus of claim 29, wherein the pilot resource selection component selects at least one allocated resource based at least in part on computing an index of the resource using a hash function involving the identifier of the apparatus and the current communications frame identifier.

31. The apparatus of claim 27, wherein the plurality of allocated resources relate to a number of tones in a collection of orthogonal frequency division multiplexing (OFDM) symbols.

32. The apparatus of claim 31, wherein one or more apparatuses transmit pilot signals over disparate tones of an OFDM symbol corresponding to the at least one allocated resource.

33. The apparatus of claim 27, further comprising a scrambling component that scrambles the pilot signal based at least in part on an identifier of the apparatus.

34. The apparatus of claim 27, further comprising a transmission silencing component that ceases transmission over one or more of the plurality of allocated resources.
